(19) United States
(12) Patent Application Publication
(10) Pub. No.: US 2024/0227296 A1
(43) Pub. Date: Jul. 11, 2024

(54) EXTRUDER FOR A THREE-DIMENSIONAL PRINTER

(71) Applicant: EELO GROUP PTY LTD, Ravenhall, Victoria (AU)

(72) Inventor: ELI GOMEZ-KERVIN, FOOTSCRAY (AU)

(21) Appl. No.: 18/559,320

(22) PCT Filed: May 9, 2022
(86) PCT No.: PCT/AU2022/050435

§ 371 Date: Nov. 6, 2023

(30) Foreign Application Priority Data
May 7, 2021 (AU) 2021901372

(51) Int. Cl. B29C 64/329; B29C 64/209; B29C 64/295; B33Y 30/00

(52) U.S. Cl. CPC B29C 64/329; B29C 64/209; B29C 64/295; B33Y 30/00

(57) ABSTRACT

An extruder for a 3-dimensional (3D) printer includes a motor having an upright drive shaft, and a print head having a gearbox, a hopper body, and a shroud sequentially coupled in a top-down arrangement with the hopper body positioned adjacent the motor. The print head further includes a nozzle disposed at a bottom portion of the shroud, a barrel in fluid communication with the nozzle and the hopper body, and a screw conveyor moveably supported within the barrel and the hopper body such that the screw conveyor is disposed in rotatable engagement with the upright drive shaft of the motor via gearing arrangement of the gearbox. Upon rotation by the upright drive shaft in a first direction, the screw conveyor is axially retractable in relation to the nozzle for selectively defining a positive displacement pump that controls a flow of feedstock output by the nozzle.

### TECHNICAL FIELD

The presently disclosed subject matter generally relates to the field of devices for use in 3-Dimensional (3D) Printing. Particularly, the present subject matter relates to an extruder for a 3D printer that prevents yet to be extruded feedstock from inadvertently oozing via a nozzle and hence, blobbing or stringing from the nozzle during the printing process while also implementing specific types and arrangements, or configurations, of components within the extruder and a point of attachment on the extruder that offers a low centre of gravity to the extruder for maximum stability, especially at the nozzle of the extruder, during the printing process.

### BACKGROUND

Many configurations of 3-dimensional (3D) printers and extruders used in such 3D printers have been developed in the past in an attempt to achieve easy, fast, and error-free printing of 3D structures but have largely remained unsuccessful in achieving one or more of the three aforementioned aspects as a poorly designed extruder of a 3D printer may result in negatively affecting, or impacting, the print quality, for example, geometrical aspects (size and/or shape) of the 3D structure. The quality of the printed 3D structure using these poorly designed extruders and 3D printers may, consequently, not confirm, adhere, or remain within desired, and stipulated, tolerances.

Traditionally, conventionally designed 3D printers and the extruders of such 3D printers use feedstock in the form of filaments. These filaments are extruded, or drawn, beforehand using additional, complex, and cost-intensive processes to produce these filaments to pre-defined lengths but, more importantly, precise and consistent diameters that may be cumbersome or challenging processes for manufacturers to implement. Moreover, as these additional processes need to be carried out beforehand for producing the filament using specific cost-intensive manufacturing processes, use of the feedstock in filament form is known to drive up the overall cost of printing as well as the 3D structures that are printed using these filaments.

Also, as these filaments are available for use in discrete lengths, an operator of the 3D printer would have to pause any printing operation for feeding, loading or spooling, the 3D printer with a filament time and again i.e., each time a previously used filament is exhausted. Consequently, this leads to a downtime of the 3D printer causing the 3D printer to require an additional amount of time for completing a scheduled printing process. Moreover, manufacture and use of the feedstock in filament form limits a number and type of materials that can be easily and cost-effectively drawn out to form the filaments while these expensive filaments continue to reduce the versatility of the 3D printing process as a whole in that these conventionally designed 3D printers and their extruders would be configured to use only these expensive yet limited number and type of materials to carry out printing processes.

In addition, the requirement to feed stock strictly in filament form when using the conventionally designed 3D printers and their extruders would lead to several other undesired effects including, amongst other things, a decreased viability of recycling the printed materials back again into filament form and where such reduced, or decreased, viability for recycling would also lead to unsustainability i.e., at least by way of decreased future availability of the printing materials to form the filaments. The decreased viability for recycling is, in turn, likely to cause higher carbon footprint on the planet besides an energy inefficient planet. In fact, even if recycling is desired, the decreased viability for recycling the printed 3D structures to feedstock particularly in the filament form may imply that only those materials, capable of being recycled, may be used to form the feedstock in the first place. Consequently, only few types of materials may be selected and implemented for use in forming the feedstock in filament form, or stated differently, there would exist a decreased possibility, or viability, in the use of other recycled and more commonly recycled materials for filament production.

Also, in many cases, a precision in the geometrical and/or dimensional specification to which these 3D structures are printed may depend not only on a level of accuracy in the movement of a print head of the extruder in the 3D printer setup as the print head moves from point to point, but also from the print head's ability to handle and dispense the required amount of feedstock from a nozzle of the print head at specific, and required, instants of time. Usually, the ability of print heads, used in conventionally designed 3D printers, to provide an optimal quantity and flow rate of the feedstock when printing the 3D structures is limited by poor, or inefficient, system design of the print head alone or an overall system design of the extruder, or the 3D printer, itself. This negatively impacts the quality control and reliability of final prints, therefore increases post processing time, and creates material wastage.

For instance, in some conventionally designed 3D printers, a motor may be mounted to the print head but located directly above the print head thus rendering the overall print head to have a high centre of gravity and thus, be of low stability, especially, when the print head needs to perform quick starts and stops where owing to a high centre of gravity, the print head may undesirably wobble in one or more axes about a gantry to which the print head is fixed thus increasing the potential for errors in the printed structure. In other instances, with use of feedstock in filament form, conventionally designed extruders are known to feed the stock by passing the filament along a passageway that terminates at a nozzle of the extruder and in which the passageway includes a melt zone prior to the nozzle. Upon melting the filament at the melt zone, it may be desired to have improved control over a flow of the melted filament out of the nozzle, but in order to control the flow, conventionally designed extruders are known to merely pull back the filament by reversing its feed direction and this merely retracts the filament from the melt zone while the melted feedstock from, and previously remnant within, the melt zone continues to ooze out of the nozzle. Therefore, the conventionally designed extruders lack the improved ability to control presence, whilst regulating amount of, feedstock in the melt zone and therefore, the conventionally designed extruders cannot output the melted feedstock at a desired flow rate from the nozzle.

Further, due to the conventional mounting of the motor directly above the print head, the motor is likely to be coupled in-line with an extruding screw of the print head thereby allowing for only a shortened length of the extruding screw to be implemented for use in many conventionally designed 3D printers. Further, when used together with one or more heaters, the shortened length of the previously known extruding screws may allow little to no flexibility at all for a desired thermal, or temperature, profile to be achieved for the feedstock along the shortened length of the previously known extruding screws.

Furthermore, typical methods of operating filament extruders or extruding screws using conventionally designed 3D printers has been known to cause undesirable effects such as oozing of the feedstock from the nozzle of the print head that may, in turn, cause blobbing of the feedstock material when the print head is stationary, or stringing of the feedstock material when the print head is moving i.e., making a pass along a predefined trajectory. Stringing and/or blobbing of feedstock material may result in the printed structure to become non-compliant with stipulated geometrical and/or dimensional tolerances, especially, where tight tolerances are used to print the structure. This negatively impacts the quality control and reliability of final prints, therefore increases post processing time, and creates material wastage.

In view of the foregoing, it would be prudent to implement an extruder for a 3D printer that overcomes the aforementioned drawbacks. Hence, there is a need for an extruder and a3D printer that obviates the need for feedstock in filament form alone, while also having improved stability and feedstock dispensation characteristics that can help achieve better printed structures compliant with geometrical and/or dimensional tolerances, especially, where tight tolerances are encountered without stringing or blobbing of feedstock material during the printing process.

### SUMMARY

The present disclosure provides an extruder for a 3-dimensional (3D) printer that eliminates, or at least substantially reduces, blobbing and/or stringing of feedstock material during routines, or sub-routines, of a printing process where a print head of the extruder is either moving or stationary.

The present disclosure also provides a print head for the extruder that helps improve the stability of the extruder, and the 3D printer as a whole, by lowering a centre of gravity of the extruder to a point of attachment on the print head using which the print head is coupled, for operably moving in relation, to a gantry. The improved stability disclosed herein can help reduce a possibility of the print head wobbling under operation and therefore help users achieve easy, fast, and error-free printing of 3D structures.

The present disclosure is also aimed at improving the flexibility and therefore, versatility of the print head to use i.e., be fed with stock materials having shapes, or forms, other than conventionally known filaments, for instance, pelletized, or granular, form. Such improved flexibility and versatility may lead to significant cost reduction by eliminating the need for costly filament production activities that were needed to be carried out previously while also improving a throughput of the extruder and therefore, an output of the 3D printer due to a continuous feed being made possible through the use of a non-filament form of feedstock material, i.e., the feedstock having pelletized, or granular, form in place of the filament form as the filaments were sized to discrete lengths so as to be fed from a spool and such spool-fed filaments would result in discrete amounts of interrupted printing time before spool replacement was carried out as opposed to an uninterrupted, and therefore, continuous printing time of the 3D printer that is achieved using embodiments of the present disclosure.

An embodiment of the present disclosure provides an extruder for a 3-dimensional (3D) printer. The extruder includes a motor having an upright drive shaft, and a print head having a gearbox, a hopper body, and a shroud sequentially coupled in a top-down arrangement with the hopper body positioned adjacent the motor. The print head further includes a nozzle disposed at a bottom portion of the shroud, a barrel in fluid communication with the nozzle and the hopper body, and a screw conveyor moveably supported within the barrel and the hopper body such that the screw conveyor is disposed in rotatable engagement with the upright drive shaft of the motor via gearing arrangement of the gearbox. Upon rotation by the upright drive shaft in a first direction, the screw conveyor is axially retractable in relation to the nozzle for selectively defining a positive displacement pump that controls a flow of feedstock output by the nozzle.

According to an aspect of the present disclosure, the motor adjacent the hopper body of the print head disposes a centre of gravity proximal to a point of attachment of the print head located on an outer surface of one of the hopper body and the shroud. In a further aspect of the present disclosure, by disposing the motor adjacent the hopper body of the print head, the motor and the print head collectively subtend the centre of gravity to be coincident with the point of attachment. In a preferred embodiment, the point of attachment is positioned on the outer surface of the shroud and located proximal to the motor for maximum stability.

According to another aspect of the present disclosure, the hopper body has at least one sidewall located distally away from the motor. The distally located sidewall defines a hopper protruding angularly therefrom. The hopper is configured to help counterbalance a weight of the motor about the point of attachment of the print head that is located on the outer surface of one of: the hopper body and the shroud.

According to another aspect of the present disclosure, the extruder further includes a suction fan installed on another sidewall of the hopper body adjacent to the distally located sidewall. In a further aspect, the shroud and the hopper body are coupled to each other in a spaced-apart relationship using a plurality of spacers therebetween. These spacers are configured to help define an air vent in fluid communication with the suction fan via a duct of the hopper body. The air vent is configured to allow heat to egress out of the hopper body, at a location proximal to the shroud, upon rotation of the suction fan.

According to another aspect of the present disclosure, the gearbox includes an outer case coterminously circumventing, and secured to, top portions of the hopper body and the motor. The gearbox further includes a cover member disposed above, and secured to, the outer case.

Furthermore, the gearbox also includes a hat member disposed above, and secured to, the cover member.

According to a further aspect of the present disclosure, the gearing arrangement of the gearbox includes a drive gear that is coupled with the upright drive shaft of the motor. The gearing arrangement also includes a compound gear that is supported on a lay shaft and has a first idler rotatably engaged with the drive gear. Further, the gearing arrangement also includes a driven gear that is rotatably engaged with a second idler of the compound gear and threadably coupled to the conveyor screw using a threaded internal nut. Furthermore, the gearing arrangement also includes a pair of top and bottom bushings seated within the cover member and a base of the outer case of the gearbox respectively. The top and bottom bushings axially secure the position of the driven gear and the threaded internal nut therebetween while facilitating the axial retraction of the screw conveyor when the upright drive shaft and the screw conveyor are rotated by the motor in the first direction.

According to a further aspect of the present disclosure, the threaded internal nutis threadably engaged with the screw member and rigidly coupled with the driven gear, and is adapted to axially abut with the top bushing. According to a further aspect of the present disclosure, a weight of the gearing arrangement in the gearbox is in line with, or at least majorly incident along, an axis of the screw conveyor.

According to a further aspect of the present disclosure, the drive gear, the compound gear, and the driven gear are of successively increasing weights.

According to another aspect of the present disclosure, the drive gear, the compound gear, and the driven gear are spur gears of successively increasing diameters.

According to another aspect of the present disclosure, a reduction ratio between the drive gear and the driven gear is 15.2:1.

According to another aspect of the present disclosure, the barrel is configured to support at least two heating elements thereon.

According to a further aspect of the present disclosure, a position of each heating element is adjustable along a length of the barrel.

According to a further aspect of the present disclosure, a temperature of each heating element is individually user-selectable via a control unit of an auto feeder for providing a desired temperature profile along the length of the barrel.

According to another aspect of the present disclosure, the screw conveyor is an elongated stepped rod having a helically threaded top portion, a trapezoidally threaded middle portion, and a helically grooved bottom portion that is slidably disposed, at least in part, within the barrel.

According to a further aspect of the present disclosure, the helically threaded top portion is characterized with one of: right handed or left handed threads, and the trapezoidally threaded middle portion and the helically grooved bottom portion are characterized with another one of: right handed or left handed threads.

According to a further aspect of the present disclosure, the helically grooved bottom portion of the screw conveyor is moveably positioned within at least one of the barrel in the shroud and an elongated conduit of the hopper body co-axial to, and in fluid communication with, the barrel.

According to another aspect of the present disclosure, rotation of the upright drive shaft and the screw conveyor facilitates a pressure drop through a control volume of the positive displacement pump defined between the screw conveyor, the nozzle, and the barrel. The control volume is continuously variable with an amount of retraction and instantaneous movement between initial and final positions of the screw conveyor within the barrel and relative to the nozzle.

According to another aspect of the present disclosure, the first direction is a direction opposite to a second direction in which the screw conveyor is rotated by the motor using the upright drive shaft for performing a printing operation using the print head.

According to a further aspect of the present disclosure, the second direction is a clockwise direction and the first direction is a counter-clockwise direction in which the upright drive shaft and the screw conveyor are rotated by the motor to axially retract the screw conveyor relative to the nozzle.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices and processes that are consistent with the disclosed subject matter as claimed herein.

FIG. 1 is a perspective view of an extruder showing a motor and a print head having a gearbox, a hopper body and a shroud in accordance with an embodiment of the present disclosure;

FIG. 2 is a right view of the extruder from FIG. 1 showing a nozzle of the print head in accordance with an embodiment of the present disclosure;

FIG. 3 is a front view of the extruder taken from FIG. 1;

FIGS. 4, 5, and 6 are left, top, and bottom views of the extruder corresponding to the front view of the extruder from FIG. 3;

FIG. 7 is a sectional view of the extruder;

FIG. 8 is a front view of a screw conveyor of the print head in accordance with an embodiment of the present disclosure;

FIGS. 9 and 10 are sectional views of the extruder at different instants of operation, in accordance with an embodiment of the present disclosure;

FIG. 11 is a sectional perspective view of the extruder showing a suction fan, and an air vent defined between the shroud and the hopper body, the air vent located in fluid communication with the suction fan via a duct of the hopper body, in accordance with an embodiment of the present disclosure;

FIG. 12 shows an exemplary control unit of an auto-feeder that may be provided for use with two or more heating elements of the extruder, in accordance with an embodiment of the present disclosure; and

FIG. 13 shows the extruder having alternative points of attachment for use in mounting the extruder to the print head.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Reference throughout this specification to “a embodiment,” “an embodiment,” or “one embodiment” means that a particular feature, structure, or characteristic described in connection with the embodiment is included in at least one embodiment of the disclosed subject matter. Thus, appearances of the phrases “in an embodiment” or “in one embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other structures, components, and materials as substitution or replacement to the structures, components, materials disclosed herein. In other instances, one or more structures, components, and materials disclosed herein may altogether be omitted, and equivalent structures, components, materials may be used in lieu thereof. Also, in the present disclosure, well-known structures, materials, or operations are not shown or described in detail to avoid obscuring aspects of the disclosed subject matter.

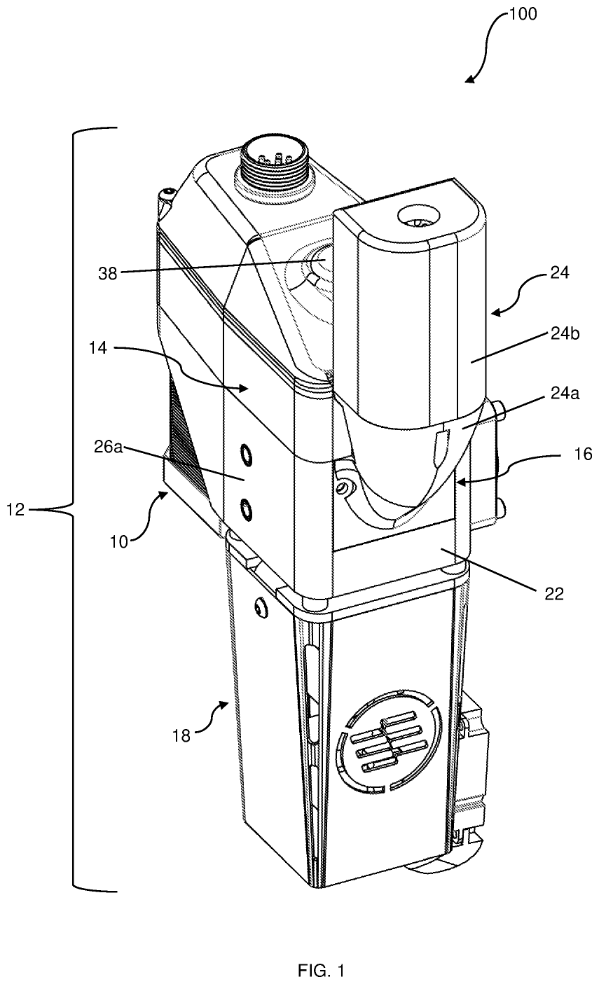

FIG. 1 is a perspective view of an extruder 100 showing a motor 10 and a print head 12 having a gearbox 14, a hopper body 16 and a shroud 18 in accordance with an embodiment of the present disclosure. The motor 10 shown in the view of FIG. 1 may include, for example, a NEMA17 Stepper motor having a length of 60 millimeter (mm). However, in alternative configurations of the extruder 100, other types of electric motors known to persons skilled in the art may suitably be implemented in lieu of the NEMA17 Stepper motor for forming the motor 10 of the present disclosure. For sake of brevity, and to aid the reader in understanding the present disclosure with maximum clarity, obscuring details to one or more components related to the extruder 100 has been wilfully omitted from explanation in the present disclosure.

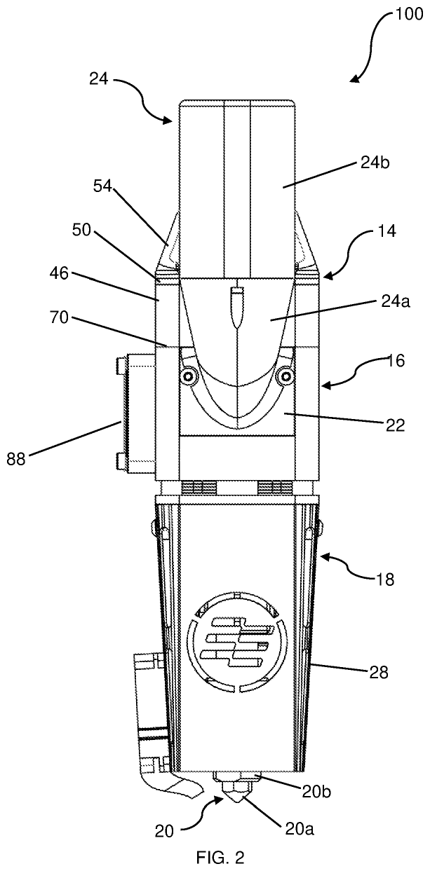

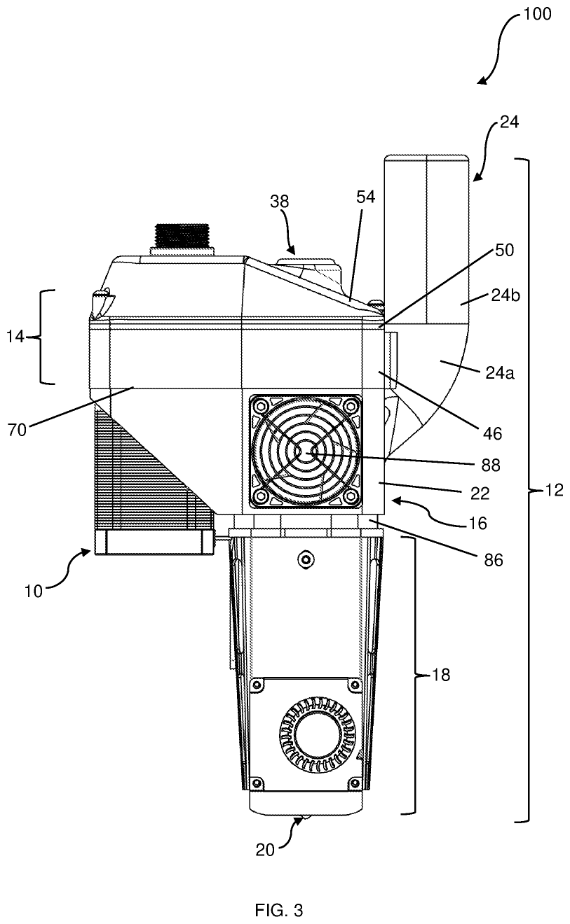

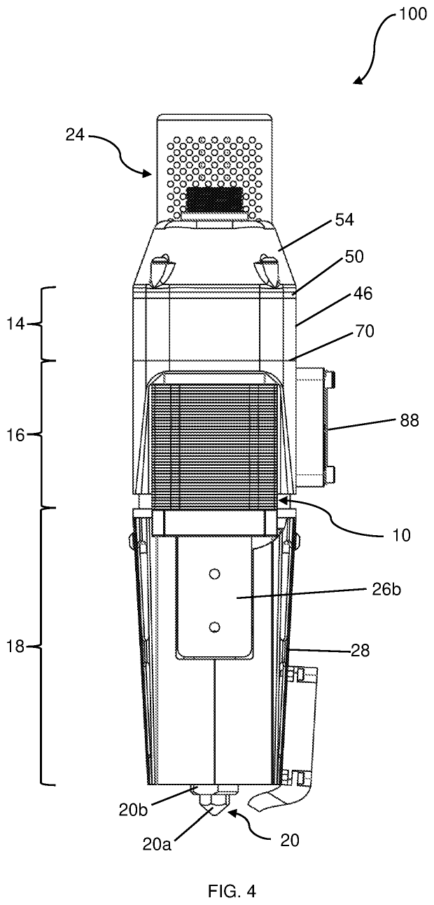

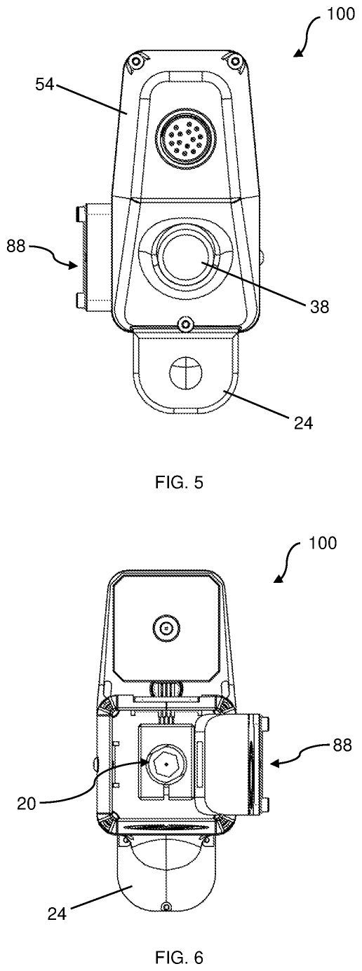

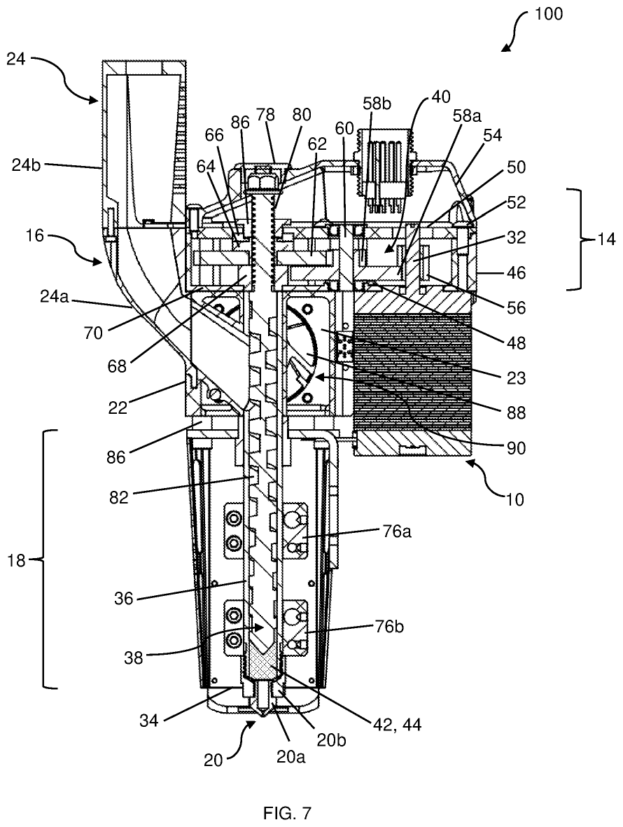

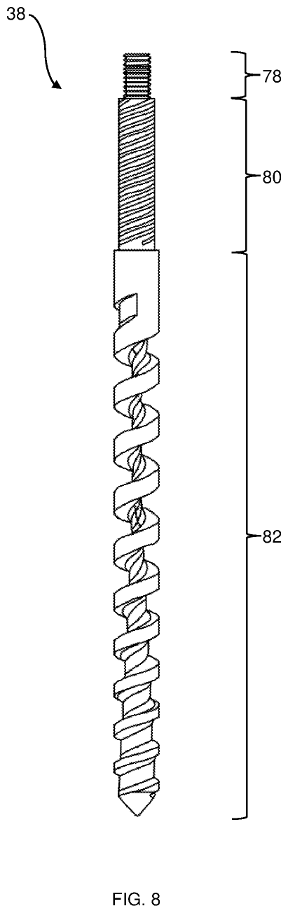

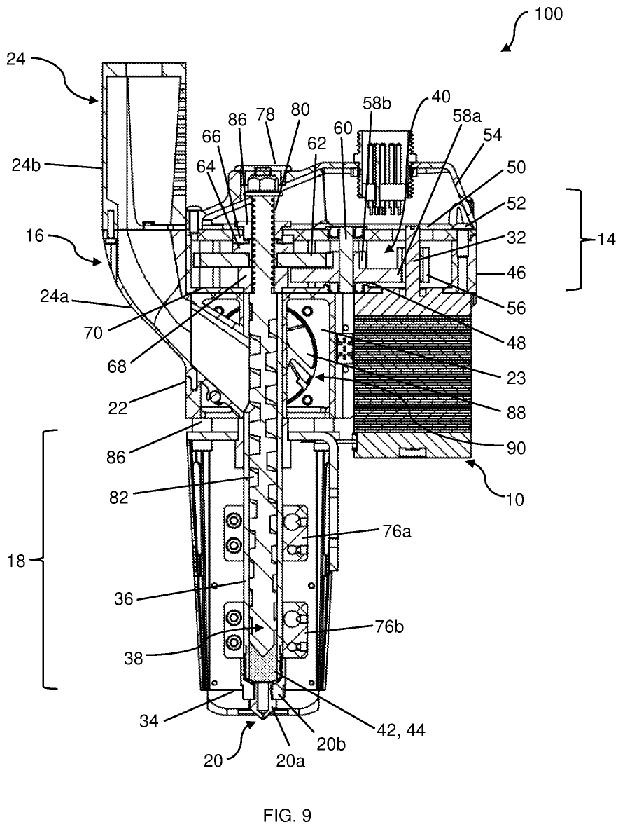

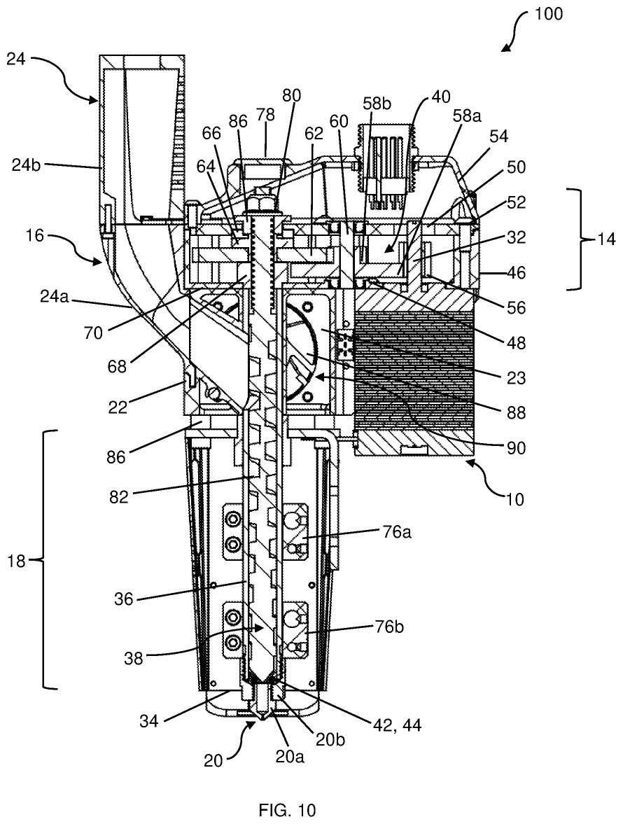

FIG. 2 is a right view of the extruder 100 from FIG. 1 showing a nozzle and nozzle adapter arrangement 20 of the print head 12 in accordance with an embodiment of the present disclosure. FIG. 3 is a front view of the extruder 100 taken from FIG. 1, and FIGS. 4, 5, and 6 are left, top, and bottom views of the extruder 100 corresponding to the front view of the extruder 100 from FIG. 3. Explanation to the FIGS. 1-6 will be made hereinafter in conjunction with explanation to FIGS. 7-10 in which FIG. 7 is a sectional view of the extruder 100, FIG. 8 is a front view of an exemplary screw conveyor 38 of the print head 12 in accordance with an embodiment of the present disclosure, and FIGS. 9 and 10 are sectional views of the extruder 100 at different instants of operation, in accordance with an embodiment of the present disclosure.

As shown in the view of FIG. 1, the gearbox 14, the hopper body 16 and the shroud 18 of the print head 12 are successively connected in a top-down arrangement with the hopper body 16 positioned adjacent the motor 10. Additionally, the hopper body 16 has a sidewall 22 located distally away from the motor 10. As shown, the distally located sidewall 22 has a hopper 24 protruding angularly therefrom. The hopper 24 may be mounted to the distally located sidewall 22 at a hopper mounting point. The hopper mounting point advantageously allows a wide range of hoppers to be used by the extruder 100. The hopper 24 is configured to, not only allow connection to an auto feeder (not shown) for receiving feedstock, for instance, in pelletized or granular form therefrom, but also help in counterbalancing a weight of the motor 10 about a point of attachment 26 of the print head 12 that is located on an outer surface of the shroud 18, when the extruder 100 is used in operation. Additionally, the hopper 24 is configured as a modular assembly, having a base module 24a and an upper module 24b. The upper module 24b may be selected from several design, based upon the requirements of the extruder 100. In an example, the upper module 24b may be in a configuration for non-automated feed. In another example, the upper module 24b may be configured to facilitate auto feeding. The hopper 24 or any hopper module 24a, 24b may be hot swapped during operation of the extruder 100. The base module 24a may be configured with a level sensor, such as an infrared sensor, in communication with the auto feeder for sensing feedstock level of the hopper 24.

In an embodiment, due to the motor 10 being positioned adjacent the print head 12, and particularly, adjacent the hopper body 16 of the print head 12, a centre of gravity for the extruder 100 is configured to lie proximal to the point of attachment 26 of the print head 12 that is located on an outer surface 28 of the hopper body 16 as shown in the view of FIG. 2. In fact, in a preferred embodiment, for maximum stability of the extruder 100 in operation, each of the motor 10 and the print head 12 are configured to be adjacent each other such that the motor 10 and the print head 12 collectively subtend the centre of gravity in a manner that allows the centre of gravity to be coincident with the point of attachment 26. That is, it can be contemplated to provide an attachment apparatus (not shown) at that point of attachment 26 that is likely to be proximal to, or even exactly at, the centre of gravity i.e., the centre of mass of the extruder 100.

As shown best in the view of FIG. 7, the motor 10 has an upright drive shaft 32. In addition, the print head 12 includes the nozzle 20 disposed at a bottom portion 34 of the shroud 18. The print head 12 also include a barrel 36 in fluid communication with the nozzle and nozzle adapter arrangement 20, and the hopper body 16. The nozzle 20a is configured with a fastening means, which in this preferred embodiment is in the form of a thread, for fastening to the nozzle adapter 20b. This advantageously allows different types and sizes of nozzles to be mounted to the print head 12. The nozzle adapter 20b is also configured with a fastening means, which in this preferred embodiment is in the form of a thread, for fastening to the barrel 36. This advantageously allows different sized nozzle adapters to allow for a larger variety of types and sizes of nozzles to be mounted to the print head 12. The print head 12 also includes the screw conveyor 38 that is moveably supported within the barrel 36 and the hopper body 16 such that the screw conveyor 38 is disposed in rotatable engagement with the upright drive shaft 32 of the motor 10 via a gearing arrangement 40 of the gearbox 14. By rotating the upright drive shaft 32 in a first direction, the screw conveyor 38 can be axially retracted in relation to the nozzle 20 for selectively defining a positive displacement pump 42 that controls a flow of feedstock output by the nozzle 20 as shown best in the views of FIGS. 9 and 10, explanation to which will be made later herein in conjunction with FIGS. 9 and 10 respectively.

In an embodiment as best shown in the view of FIG. 7, the gearbox 14 includes an outer case 46 coterminously circumventing, and secured to, top portions of the hopper body 16 and the motor 10. The outer case 46 may be configured to secure with the hopper body 16 and the motor 10 using, for example, socket heads with cap screws 48. Further, the gearbox 14 includes a cover member 50 disposed above, and secured to, the outer case 46, for example, socket heads with cap screws 52. Furthermore, the gearbox 14 also includes a hat member 54 disposed above, and secured to, the cover member 50 using, for example, a snap fit of the hat member 54 onto the cover member 50 and/or with use of socket heads with cap screws. Although socket heads with cap screws and the snap fit are disclosed as securement means herein, a scope of the present disclosure is not limited to such means of securement. In alternative embodiments, the socket heads with cap screws may be replaced by another type of fastener (not shown), for example, HEX bolts and nuts, rivets, or another type of fastening arrangement including, but not limited to, use of adhesion or other bonding techniques for accomplishing securement as known to persons skilled in the art.

In an embodiment as best shown in the view of FIG. 7, the gearing arrangement 40 of the gearbox 14 includes a drive gear 56 that is coupled with the upright drive shaft 32 of the motor 10. The gearing arrangement 40 also includes a compound gear 58 that is supported on a lay shaft 60 and has a first idler 58a rotatably engaged with the drive gear 56. Further, the gearing arrangement 40 also includes a driven gear 62 that is rotatably engaged with a second idler 58b of the compound gear 58 and threadably coupled to the conveyor screw using a threaded internal nut 64.

Further, the gearing arrangement 40 also includes a pair of top bushing 66 and the bottom bushing 68 seated within the cover member 50 and a base 70 of the outer case 46 of the gearbox 14 respectively. The top bushing 66 and the bottom bushing 68 axially secure the position of the driven gear 62 and the threaded internal nut 64 therebetween while facilitating the axial retraction of the screw conveyor 38 when the upright drive shaft 32 and the screw conveyor 38 are rotated by the motor 10 in the first direction, as will be explained later in conjunction with FIGS. 9 and 10 respectively.

With continued reference to FIG. 7, in an embodiment, the threaded internal nut 64 is threadably engaged with the screw member and rigidly coupled with the driven gear 62. Further, the threaded internal nut is adapted to axially abut with the top bushing 66. In embodiments herein, it is contemplated during manufacture of the gearing arrangement 40 used in the gear box, a weight of the gearing arrangement 40, or at least a major component of the weight is in line with, or at least incident on, an vertical axis of the screw conveyor 38. In a further embodiment, the drive gear 56, the compound gear 58, and the driven gear 62 may be of successively increasing weights. Additionally, in a further embodiment, the drive gear 56, the compound gear 58, and the driven gear 62 are spur gears of successively increasing diameters. It is hereby envisioned that the successively increasing weights and/or diameters can beneficially render the centre of gravity for the extruder 100 close to the point of attachment 26 shown in FIGS. 1, 4 and 13 respectively.

In a further embodiment, a reduction ratio between the drive gear 56 and the driven gear 62 is 15.2:1. In an exemplary configuration of the gearing arrangement 40, the drive gear 56 on the drive shaft 32 of the motor 10 may include 10 teeth, the driven gear 62 on the screw conveyor 38 may include 48 teeth while the first and second idlers 58a, 58b of the compound gear 58 may include 12 and 38 teeth respectively. Also, regardless of whether the drive gear 56 and the driven gear 62 are disposed in indirect mesh with each other, i.e., via the compound gear 58 disclosed herein, or in direct mesh with each other as contemplated in alternative embodiments herein, the disclosed reduction ratio of 15.2:1 between the drive and driven gears 56, 62 is implemented to provide a high torque to weight ratio that can adequately power rotational movement, by overcoming inertia (of rest or of motion), of the screw conveyor 38 during operation of the extruder 100.

Further, persons skilled in the art will acknowledge that in the exemplary configuration of the gearing arrangement 40 shown and disclosed herein, the drive gear 56, the compound gear 58 and the driven gear 62 of the gearing arrangement 40 are configured to operate such that rotations of the drive and driven gears 56, 62 would occur in one of clockwise or counter-clockwise directions while the first and second idlers 58a, 58b of the compound gear 58 would be driven by the drive gear 56 and hence, rotate in another one of the directions i.e., a direction opposite to that in which the drive and driven gears 56, 62 rotate.

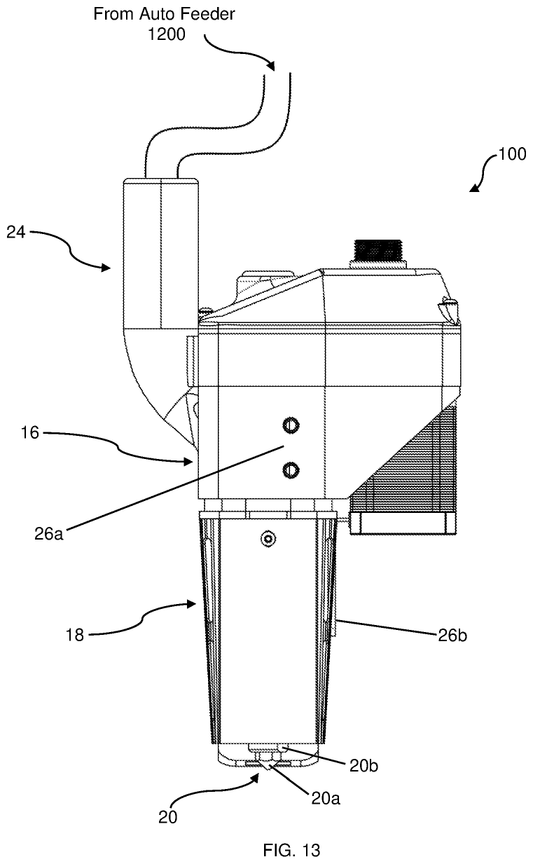

In an embodiment, the barrel 36 is configured to support at least two heating elements 76 thereon. In the example shown best by way of FIG. 7, the barrel 36 supports two heating elements 76, however, in other configurations, more than two, for example, three, four or more heating elements 76 may be implemented for use depending on specific requirements of a 3D printing application. In a further embodiment, a position of each of the heating elements 76 is adjustable along a length L_{b} of the barrel 36, to advantageously provide more control over temperature profiles to enable suitability for a wide variety of feedstock materials. Additionally, in a further embodiment, a temperature of each heating element 76 is individually selectable for providing a desired temperature profile along the length L_{b} of the barrel 36. In an exemplary configuration, each of the heating elements 76 may be embodied as a block, for example, a top block 76a and a bottom block 76b, each block 76a, 76b capable of operably generating heat independently of the other. Also, in a preferred embodiment herein, the individual control of heat i.e., for each heating element 76a, 76b can be accomplished at a control unit 1202 of an auto feeder 1200 provided in the 3D printer setup as shown exemplarily in view of FIG. 13. In another embodiment, the control unit 1202 is built into the auto feeder 1200 or an adapter if automated feeding is not required or desired in accordance with user preference.

Although a block shaped has been disclosed herein, it is to be noted that a number, type, shape, size and configuration of the heating element 76 is merely explanatory and illustrative in nature, and therefore, the present disclosure should not be construed as being limited thereto. Rather, it will be appreciated that in alternative, or preferred, configurations, heating elements of other shapes or forms, for example, heat rings, that are individually positionable and temperature controlled using the main/central/master control unit, can be contemplated for ready use and implementation in lieu of the block shaped heating element disclosed herein without deviating from the spirit of the present disclosure. Such modifications or substitutions are hereby contemplated for, inter alia, achieving finer control over the temperature profile of the barrel 36 i.e., along the length L_{b}.

In an embodiment as best shown in the view of FIG. 8, the screw conveyor 38 is an elongated stepped rod having a helically threaded top portion 78, a trapezoidally threaded middle portion 80, and a helically grooved bottom portion 82 that is slidably disposed, at least in part, within the barrel 36. Further, the helically threaded top portion 78 is characterized with one of right handed or left handed threads, and the trapezoidally threaded middle portion 80 and the helically grooved bottom portion 82 are characterized with another one of right handed or left handed threads. For example, if the helically threaded top portion 78 includes left handed threads, the trapezoidally threaded middle portion 80 and the helically grooved bottom portion 82 would be characterized with right handed threads and right handed grooves respectively.

Referring to the views of FIGS. 9 and 10, the helically grooved bottom portion 82 of the screw conveyor 38 is moveably positioned within the barrel 36 in the shroud 18. In operation of the extruder 100 disclosed herein, rotation of the upright drive shaft 32 and the screw conveyor 38 in the first direction facilitates a pressure drop through a control volume 44 of the positive displacement pump 42 defined between the screw conveyor 38, the nozzle 20 and the barrel 36. The control volume 44 disclosed herein is a volume within the barrel 36 between the helically grooved bottom portion 82 of the screw conveyor 38 and the nozzle 20. This control volume 44 is continuously variable with an amount of retraction and instantaneous movement between initial and final positions of the screw conveyor 38 relative to the nozzle 20 as shown exemplarily in the view of FIGS. 9 and 10 respectively. This advantageously provides significantly greater and more precise control of the molten material in the control volume and nozzle in comparison with existing methods comprising altering un-melted feedstock outside of the melt zone.

The first direction disclosed herein is a direction that is opposite to a second direction in which the screw conveyor 38 would be rotated by the motor 10, using the upright drive shaft 32, for performing a printing operation using the print head 12. Optionally, and in an exemplary embodiment, the second direction may be a clockwise direction and the first direction may be a counter-clockwise direction. In this exemplary embodiment, the first direction i.e., the counter-clockwise direction may be designated, concomitantly by design, as the direction in which the upright drive shaft 32 and the screw conveyor 38 are rotated by the motor 10 for axially retracting the screw conveyor 38 relative to the nozzle 20. Although the first and second directions are stated as being counter-clockwise and clockwise directions respectively, a contrariwise may be true when a handedness of threading on the helically threaded top portion 78 alone, and an opposite handedness of threading on each of the trapezoidally threaded middle portion 80 and the helically grooved bottom portion 82 of the screw conveyor 38 are mutually reversed.

Accordingly, by axial retracting the screw conveyor 38 relative to the nozzle 20, the control volume 44 in the barrel 36 between the screw conveyor 38 and the nozzle 20 can be varied. However, this change in volume is brought about relatively quickly to cause a relatively quick change in pressure, both adequately enough and controllably rapid, so as to be effective in preventing the outflow of feedstock from the nozzle 20 and therefore, an oozing of the feedstock out of the nozzle 20 when melted feedstock has reached, or is about to reach, an outlet of the nozzle 20 which would otherwise occur when high pressure i.e., pressure higher than ambient pressure exists between an inside of the barrel 36, particularly, the control volume 44 defined in the barrel 36 between the screw conveyor 38 and the nozzle 20 and that, as disclosed earlier, is varied by movement of the screw conveyor 38 relative to the nozzle 20. Therefore, with implementation of embodiments disclosed herein, the feedstock melted upon traversing the barrel 36 adjacent to the heating elements 76 may be prevented from oozing out of the nozzle 20.

It is hereby further contemplated that the trapezoidal screw thread on the middle portion 80 of the screw conveyor 38 is configured to not only transfer but also translate rotational power into causing axial movement of the screw conveyor 38 in a way that minimal effort and time is incurred. To that end, or effect, it can be further contemplated to modify configurations of the trapezoidal thread, for example, by including multi-start threads that are commonly known to have more than one helix and therefore, multiple launch points around a leading end of the trapezoidally threaded middle portion 80 of the screw conveyor 38 for quick start and stop of movement of the screw conveyor 38. Additionally, or optionally, if these multi-start threads of the trapezoidally threaded middle portion 80 are configured as increased pitch threads, they could be used for transferring, and translating, forces in an even quicker manner reducing system latency of the extruder 100 to a minimum when axially retracting the screw conveyor 38 relative to the nozzle 20.

Also, by positioning the motor 10 parallel i.e., to one side of the screw conveyor 38, the screw conveyor 38 of the present disclosure can have a length ranging from, for example, at least 1 to 70 percent extended when compared to conventional methods of mounting the motor 10 i.e., in-line with the screw conveyor 38, considering a height of such extruder 100 is kept similar to a height of the print head 12 disclosed herein. An advantage of having the screw conveyor 38 with extended length is to allow a majority of such screw conveyor 38 of extended length to be used for forming the helically grooved bottom portion 82 of the screw conveyor 38 thereby allowing a large throughput of feedstock from the nozzle 20 of the print head 12 if required to print a structure i.e., a prototype, a working model, or even a product. Also, as the temperature of each of the heating elements 76 and the position at which each of the heating elements 76 is located along the length L_{b} on the barrel 36 can be varied, a desired, or optimum, temperature profile of the feedstock can be achieved for the extended length of the screw conveyor 38 and the concomitant length L_{b} of the barrel 36. Moreover, this temperature profile resolved to a desired finer resolution by use of the extended length of the screw conveyor 38 that consequently aids in increasing a number of heating elements that can each be varied in position along the length of the barrel 36 and set at a desired temperature that is independent of the working temperatures associated with other heating elements on the barrel 36. Further, it is hereby envisioned that users could control a rate of feedstock outflow from the nozzle 20 not only from stopping the motor 10 and the screw conveyor 38 as a consequence of stopping the motor 10, rather, users of the print head 12 disclosed herein, with implementation of the embodiments disclosed herein, have an improved degree of control in the outflow, or the flow rate, of the feedstock from the nozzle 20 by also reversing a direction of rotation of the drive shaft 32 of the motor 10 and the corresponding direction of the screw conveyor 38 via the gearing arrangement 40 from the second direction to the first direction, for example, clockwise to counter-clockwise direction for both the drive shaft 32 and the screw conveyor 38 until the bottom bushing 68 abuts with a stepped portion of the screw conveyor 38 as shown in the view of FIG. 9. This finite and quick movement by rotation of the screw conveyor 38 relative to the nozzle 20 can help change the pressure at the control volume 44 of the barrel 36 defined between the screw conveyor 38 and the nozzle 20 fairly easily and quickly, in the order of milliseconds (10⁻³ s), or microseconds (10⁻⁶ s), or even nanoseconds (10⁻⁹ s).

Referring to FIGS. 9 and 10, with displacement, or axial movement, of the screw conveyor 38 within the barrel 36 and such quick instantaneous movement of the screw conveyor 38 between its initial and final positions results in a coterminous change in not only the volume but also the pressure at the control volume 44 of the positive displacement pump 42. For example, when retracted, the screw conveyor 36 can increase an amount of the control volume 44 and configure the control volume 44 to act as the positive displacement pump 42, or stated differently, a suction pump that can suck the feedstock away from the nozzle 20 and back into the control volume 44 of the barrel 36. This sucking of the feedstock can help prevent the feedstock from oozing out of the nozzle 20, thereby preventing other undesirable effects resulting from oozing, for example, blobbing or stringing of the feedstock when printing the structure.

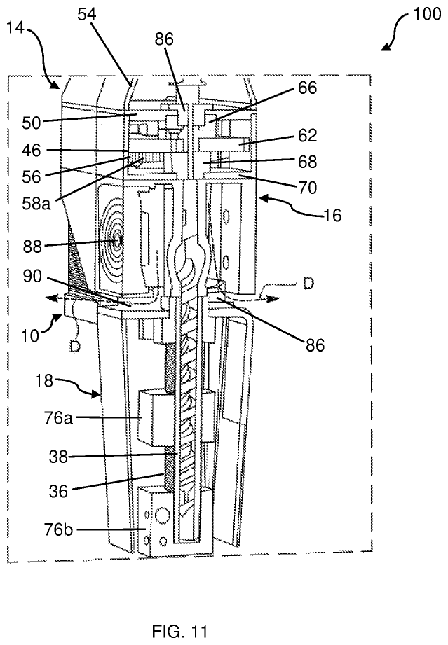

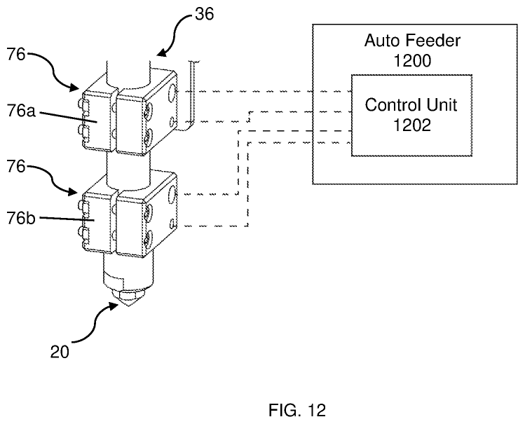

FIG. 11 is a sectional perspective view of the extruder 100 showing a suction fan 88, and an air vent depicted by a dashed line and denoted using reference letter ‘D’. As shown, the suction fan 88 is installed on another sidewall 23 (see FIGS. 9 and 10) of the hopper body 18 that is located adjacent to the distally located sidewall 22. Further, as shown, the shroud 18 and the hopper body 16 are coupled to each other in a spaced-apart relationship using a plurality of spacers 86 therebetween. The air vent D is defined, with the help of the spacers 86, between the shroud 18 and the hopper body 16. The air vent D is located in fluid communication with the suction fan 88 via a duct 90 of the hopper body 16. As the air vent D extends in fluid communication with the duct 90, as shown, the air vent D is configured to provide one or more pathways of movement for air sucked by the fan 88, in operation. In this embodiment, the air vent D is configured to draw airflow into the hopper body, through cooling channels in the hopper body. The airflow passes over a mounting plate, in which the shroud 18 is mounted to, causing heat to be transferred, via conventional heat transfer, from the shroud to the mounting plate. In another embodiment, the air vent D is configured to allow heat to egress out of the hopper body 16, at a location proximal to the shroud 18, upon rotation of the suction fan 88. During operation of the extruder 100, it is envisioned that heat from the heating elements 76a, 76b may travel upwards, and owing to convection of heat together, and with the air sucked into the duct 90 of the hopper body 16 by the suction fan 88, the sucked air from the suction fan is allowed to mix with the heat in the duct 90. Thereafter, the air vent D allows for the heated air to exit the hopper body 16 and the shroud 18 easily and quickly thereby keeping the overall extruder 100 within permissible operating temperature limits while the individual heating elements 76a, 76b continue to achieve the desired temperature profile along the length L_{b} of the barrel 36.

FIG. 12 shows an exemplary control unit 1202 of an auto-feeder 1200 that may be provided for use with the at least two heating elements 76, for example, heating elements 76a and 76b as shown. The control unit 1202 can be implemented by way of a processor (e.g., a single or multiple processors) or other hardware processing circuit, using which functions consistent with the present disclosure can be accomplished. That is, the control unit 1202 may be configured to, amongst other things, vary a temperature of each heating element 76, for example, heating element 76a and heating element 76b independently of each other. Moreover, the control unit 1202 may also include one or more pre-set or pre-defined thermostatic threshold functions configured therein and using such pre-configured logic steps, may initiate, discontinue, or resume a supply of electric power to respective ones of the heating elements 76a, 76b. As disclosed earlier herein, a number of heating elements 76 used is non-limiting of this disclosure. Accordingly, the control system 1202 can be configured to simultaneously, and precisely, control operation of any number of heating elements 76 that may be used in the extruder 100. The control unit 1202 may be configured to facilitate the automated feeding of the hopper 24 via the level sensor being tripped when a predetermined feedstock level is reached.

Also, methods of encompassing such pre-defined logic of temperature regulation for each of the heating elements 76a, 76b may be embodied as machine-readable instructions that are stored on a computer-readable medium, and which may be non-transitory such as hardware storage devices (e.g., RAM (random access memory), ROM (read-only memory), EPROM (erasable, programmable ROM), EEPROM (electrically erasable, programmable ROM), hard drives, and flash memory). The processor of the control system 1202 can execute software instructions or code that is stored on a non-transitory computer-readable storage medium to perform functions that are consistent with the present disclosure. The software code may include, for example, instructions to display one or more user-selectable options for requesting a user via a graphical user interface (GUI) and to request the user for inputting data pertaining to selection of temperatures, or temperature thresholds, for each of the heating elements 76a, 76b. As an example, the processor of the control unit 1202 may use these software codes.

FIG. 13 shows the extruder 100 having alternative points of attachment 26a, 26b for use in mounting any attachment apparatus (not shown). As best shown in the views of FIGS. 1 and 13, the first alternative point of attachment 26a is located on the outer surface 22 of the hopper body 16. In particular, the point of attachment 26a may be positioned at a sidewall of the hopper body 16 opposite to the suction fan 88 mounted on the hopper body 16. Additionally, as shown in the views of FIGS. 4 and 13, the secondary alternative point of attachment 26b may be positioned on the outer surface 28 of the shroud 18 and located proximal to the motor 10 for maximum stability. Such configurations of the extruder 100 can allow improved versatility on the part of the extruder 100 when the extruder 100 is to be mounted to a gantry of the 3D printer.

With the specific arrangement of the motor 10 i.e., adjacent the print head 12, the centre of gravity of the entire extruder 100 may be coincide with, or at least be proximal to, the point of attachment 26 that is located on the outer surface 28 of the shroud 18 or at another zone or sidewall of the extruder 100 where a relatively concentrated weight distribution exists across its corresponding spatial volume. The other zone or sidewall of the extruder corresponds to a position on an outer surface of a remainder of the extruder 100 (i.e., besides the shroud 18) that may be obtained by deducing a possible location for an additional, optional, or alternative, point of attachment 26 that is closest to the centre of gravity, or the centre of mass, for the extruder 100. It will be appreciated that with such strategic positioning of the point of attachment 26 for not only the print head 12, but also the motor 10 and therefore, the overall extruder 100, a stability of the extruder 100 may be greatly improved to prevent, or at least minimize, other undesirable effects, for instance, wobbling of the extruder 100 relative to the gantry of the 3D printer when in operation.

It will be appreciated that features of the present disclosure are susceptible to being combined in various combinations without departing from the scope of the present disclosure as defined by the appended claims. Also, various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details. The terminology used herein is for the purpose of describing particular embodiments only and is not intended to be limiting of the disclosure.

1. An extruder for a 3-dimensional (3D) printer, the extruder comprising:
a motor having an upright drive shaft; and
a print head adjacent the motor and having a gearbox, a hopper body, and a shroud sequentially coupled in a top-down arrangement with the hopper body positioned adjacent the motor, the print head comprising:
a nozzle disposed at a bottom portion of the shroud;
a barrel in fluid communication with the nozzle and the hopper body; and
a screw conveyor moveably supported within the barrel and the hopper body such that the screw conveyor is disposed in rotatable engagement with the upright drive shaft of the motor via gearing arrangement of the gearbox, and wherein the screw conveyor is axially retractable in relation to the nozzle, upon rotation by the upright drive shaft in a first direction, for selectively defining a positive displacement pump that controls, by stopping or reversing, a flow of feedstock output by the nozzle.

2. The extruder of claim 1, wherein the motor adjacent the hopper body disposes a centre of gravity proximal to a point of attachment of the print head located on an outer surface of one of: the hopper body and the shroud.

3. The extruder of claim 2, wherein by disposing the motor adjacent the hopper body of the print head, the motor and the print head collectively subtend the centre of gravity to be coincident with the point of attachment.

4. The extruder of claim 3, wherein the point of attachment is positioned on the outer surface of the hopper body and located proximal to the motor for maximum stability.

5. The extruder of claim 4, wherein the hopper body has at least one sidewall located distally away from the motor, the at least one sidewall defining a hopper protruding angularly therefrom, wherein the hopper is configured to help counterbalance a weight of the motor about the point of attachment of the print head that is located on the outer surface of one of: the hopper body and the shroud.

6. The extruder of claim 5 further comprising a suction fan installed on another sidewall of the hopper body adjacent to the distally located sidewall.

7. The extruder of claim 6, wherein the shroud and the hopper body are coupled to each other in a spaced-apart relationship using a plurality of spacers therebetween.

8. The extruder of claim 7, wherein the plurality of spacers are configured to help define an air vent in fluid communication with the suction fan via a duct of the hopper body, and wherein the air vent is configured to allow heat to egress out of the hopper body, at a location proximal to the shroud, upon rotation of the suction fan.

9. The extruder of claim 1, wherein the gearbox comprises:
an outer case coterminously circumventing, and secured to, top portions of the hopper body and the motor;
a cover member disposed above, and secured to, the outer case; and
a hat member disposed above, and secured to, the cover member.

10. The extruder of claim 9, wherein the gearing arrangement of the gearbox includes:
a drive gear coupled with the upright drive shaft of the motor;
a compound gear supported on a lay shaft and having a first idler rotatably engaged with the drive gear;
a driven gear rotatably engaged with a second idler of the compound gear and threadably coupled to the screw conveyor using a threaded internal nut; and
a pair of top and bottom bushings seated within the cover member and a base associated with the outer case of the gearbox respectively for axially securing the position of the driven gear and the threaded internal nut therebetween while facilitating the axial retraction of the screw conveyor when the upright drive shaft and the screw conveyor are rotated by the motor in the first direction.

11. The extruder of claim 10, wherein a weight of the gearing arrangement in the gearbox is in line with, or at least majorly incident along, an axis of the screw conveyor.

12. The extruder of claim 11, wherein the drive gear, the compound gear, and the driven gear are of successively increasing weights.

13. The extruder of claim 12, wherein the drive gear, the compound gear, and the driven gear are spur gears of successively increasing diameters.

14. The extruder of claim 10, wherein a reduction ratio between the drive gear and the driven gear is 15.2:1.

15. The extruder of claim 1, wherein the barrel is configured to support at least two heating elements thereon.

16. The extruder of claim 15, wherein a position of each heating element is adjustable along a length of the barrel.

17. The extruder of claim 16, wherein a temperature of each heating element is individually user-selectable via a control unit of an auto feeder for providing a desired temperature profile along the length of the barrel.

18. The extruder of claim 1, wherein the screw conveyor is an elongated stepped rod having a helically threaded top portion, a trapezoidally threaded middle portion, and a helically grooved bottom portion that is slidably disposed, at least in part, within the barrel.

19. The extruder of claim 18, wherein the helically threaded top portion is characterized with one of: right handed or left handed threads, and the trapezoidally threaded middle portion and the helically grooved bottom portion are each characterized with another one of: right handed or left handed threads.

20. The extruder of claim 18, wherein the helically grooved bottom portion of the screw conveyor is moveably positioned within at least one of the barrel in the shroud and an elongated conduit of the hopper body co-axial to, and in fluid communication with, the barrel.

21. The extruder of claim 1, wherein rotation of the upright drive shaft and the screw conveyor facilitates a pressure drop through a control volume of the positive displacement pump defined between the screw conveyor, the nozzle and the barrel, such control volume being continuously variable with an amount of retraction and instantaneous movement between initial and final positions of the screw conveyor within the barrel and relative to the nozzle.

22. The extruder of claim 1, wherein the first direction is a direction opposite to a second direction in which the screw conveyor is rotated by the motor using the upright drive shaft for performing a printing operation using the print head.

23. The extruder of claim 22, wherein the second direction is a clockwise direction and the first direction is a counter-clockwise direction in which the upright drive shaft and the screw conveyor are rotated by the motor to axially retract the screw conveyor relative to the nozzle.
